(19) United States
(12) Patent Application Publication
(10) Pub. No.: US 2005/0004905 A1
(43) Pub. Date: Jan. 6, 2005

(54) Search engine with neural network weighting based on parametric user data

(76) Inventor: Scott Dresden, Delray Beach, FL (US)

Correspondence Address: DORT CLOSE IP LAW GROUP PLLC, BOX 66148, WASHINGTON SQUARE STATION, WASHINGTON, DC, 20035, US

(21) Appl. No.: 10/902,320

(22) Filed: Jul. 29, 2004

Related U.S. Application Data
(63) Continuation of application No. 10/664,787, filed on Sep. 16, 2003.
(63) Continuation of application No. 10/390,950, filed on Mar. 18, 2003.
(60) Provisional application No. 60/451,237, filed on Mar. 3, 2003.

(51) Int. Cl. G06F 17/30

(52) U.S. Cl. 707/3

(57) ABSTRACT

The present invention provides an Internet search engine system and method that improves searching for documents or pages by processing the characteristics of a pool of data through a neural network governed by a set of rules and fuzzy logic applications. The rules and applications may be implemented at the input (or low) level or the computational/output (or high) level. Search terms and personal and situational data may activate various rule sets, and learning from human and machine feedback adjust and recombine the rule sets to improve accuracy for future searches as well as reduce computation time.

### REFERENCE TO PRIORITY DOCUMENTS

This application claims priority under 35 U.S.C. 119(e) to U.S. Provisional Patent Application 60/______ filed Mar. 3, 2003, entitled NEURALLY-PROCESSED SEARCH ENGINE WITH FUZZY AND LEARNING PROCESSES IMPLEMENTED AT MULTIPLE LEVELS by Scott Dresden, which is hereby incorporated by reference in its entirety for all purposes.

### BACKGROUND

The increasing need for finding relevant data over the Internet has produced a number of categories of data searching techniques and technology over wide area networks and in particular the Internet. Many of these techniques are included in patents and publications provided by well known industry leaders in the Internet searching business including Google™, Northern Light®, and Inktomi® (used by Yahoo!®). Various aspects of these techniques will be discussed below

With more than 4 billion Internet sites in existence, the problem of developing an effective search engine is paramount. Even though some searching techniques may provide for effective cursory searching based on input terms, the information returned to the user may still be inadequate for guidance, because of the layers of information under an entrance page. For example, a large institution such as a government, corporation, or non profit organization may easily have more than 100,000 pages or documents on one single top-level domain uniform resource locator (URL) and at least a few thousand under a single sublevel.

As can be appreciated by those skilled in the art, the instructions for searching for specific information over a large network with a limited data set, such as on a single institutional site may have different structural and architectural characteristics than instructions for searching over a nearly indefinite number of Internet pages. Attempts to organize this information may be the product of many interdisciplinary technologies ranging from library science to electrical engineering to archival taxonomy.

One very popular method for data mining, is the “scoring” method. Google, Inc. of Mountain View, Calif. has several published U.S. patent applications including 2001/0123988 entitled “Methods and Apparatus for Employing Usage Statistics in Document Retrieval” by Dean et al. and 2001/0133481 entitled “Methods and Apparatus for Providing Search Results in Response to an Ambiguous Search Query.” Both of these patent applications are hereby incorporated by reference in order to illustrate the background to the present invention.

As can be appreciated, one of the drawbacks of the “scoring” method is that like any statistical method, it can be artificially “skewed” by either a disproportionate group of users or other manipulable technique. Mechanisms can be put into place to account for these factors, the technological advances and otherwise “skewable” techniques. For example, U.S. Pat. No. 6,269,361 issued to Davis, et al. and assigned to GoTo.com of Pasadena, Calif. describes such a technique for influencing a place in the list of a search engine. As needed to detail the problem of influencing search results, this document is hereby incorporated by reference.

Google® owns other technology related to data searching techniques. For example, a recently issued U.S. Pat. No. 6,526,440 entitled “Ranking Search Results by Reranking the Results Based on Local Interconectivity by Krishna Bharat teaches the use of connectivity to determine “relevance.” However, these results are subject to “statistical” problems, although it may require an immense “effort” on the part of any single unsavory entity to intentionally skew such data in its favor. For example, a single URL, used by an entity and of particular usefulness (i.e, relevance) to the majority of people may be overtaken by an entity's URL that uses many different URLs to connect to that link, allowing manipulation by entities who may benefit from the use of “click-throughs,” mainly the sale of advertising space or pop-up screens. FIGS. 1A-C illustrate some of the various searching techniques used by this entity.

As such, scoring techniques for finding relevant documents can learn only by statistical inferences and connectivity and require a manual detection of manipulations or irregularities. For example, many URLs can point to a single site or page, which can skew the “popular” use of the statistic. Furthermore, it is assumed that “relevance” for looking for a document begs the question as to “whom is it relevant to?” The above-described described methods may be useful for persons looking for the result “relevant” to a majority of people or even a well defined subset of persons. However, users with unusual profiles or searching techniques may be excluded from effectively using these methods in looking for relevant documents over the Internet. The importance of relative criteria in searching the Internet for relevant information is not just a philosophical question, but lends itself to very practical concerns about the heuristics of the search.

There are other types of intelligent searching techniques that attempt use principles of artificial intelligence as they apply to natural language processing. U.S. Pat. No. 6,430,551 by Thelen et al. and assigned to Phillips Electronics of the Netherlands, uses pattern recognition techniques, as such

Neural networks are both a conceptual framework and a practical computing application developed in the attempt to teach computers how to model brain functioning (or other biological models) in the areas of pattern recognition of speech and vision processing. The concept of neural network computing originally applied to pattern recognition studies. The concept of neural computing requires that “rules” generated by a high level structure (such as a brain) are implemented at the “nerve” level (or the data input) to process the incoming data properly. Training mechanisms for the use of neural networks over the Internet for use in analyzing financial market data include U.S. Pat. No. 6,247,001 entitled “Method of Training a Neural Network” by Tresp et al. currently assigned to Siemens of Munich Germany, and hereby incorporated by reference.

Another adaptive intelligence mechanism applied to complex computing problems is the genetic algorithm. Genetic algorithms are components of larger computing solutions (i.e. a larger algorithm) that are usually able to adapt and combine in other algorithms. Genetic algorithms are known to those skilled in the art for various purposes, and their description may be referenced by any number of textbooks on the subject, including Introduction to Genetic Algorithms, by Melanie Mitchell (MIT Press 1996), which is hereby incorporated by reference for purposes of teaching the implementation of genetic algorithms or components. Such algorithms are also taught in U.S. Pat. No. 6,182,057, which is hereby incorporated by reference.

Bayesian logic is also referred to as fuzzy logic, which has been the focus of many types of intelligence-based computing for a couple of decades. In its most simplified form fuzzy logic is a technique for defining members of sets based on contingent and relative variables. Fuzzy logic therefore plays crucial roles in machine learning techniques where adaptation is required. The use of multiple intelligence computing techniques simultaneously has been discussed in the recent literature. The concept of the neuro-fuzzy and/or fuzzy-neuro systems is discussed at length in Fuzzy Engineering Expert Systems with Neural Network Applications by A. B. Badirui and J. Y. Cheung (John Wiley & Sons, 2002) and Soft Computing: Integrating Evolutionary, Neural and Fuzzy Systems, by A. Tettamanzi and M. Tomassini (Springer 2001). These two references are incorporated by reference in order to teach the various techniques of developing and configuring neural networks, fuzzy logic, genetic algorithms and expert systems in general. Some textual references have noted that neural networks may not be good for searching algorithm applications mainly because neural network rules are implemented a low levels, which may be impractical with data input as complex as natural language expressions, which are typically used in an internet search. Such a concept is discussed in Evolutionary Algorithms for Data Mining, by Alex Freitas, Springer, 1998, p. 4, which is hereby incorporated by reference.

An example of multiple use of artificial intelligence techniques over networks is described in U.S. Pat. No. 6,327,550 entitled “Method and Apparatus for System State Monitoring Using Pattern Recognition and Neural Networks” by Vinberg et al. and currently assigned to Computer Associates Think, Inc., of Islandia, N.Y. The Vinberg reference teaches the. use of state vectors as they would be applied to networks. Other interactive multiple intelligence mechanisms are described in U.S. Pat. No. 5,249,259 (“Genetic Algorithms for Designing Neural Networks”) and U.S. Pat. No. 5,727,130 (“Genetic Algorithm for Constructing and Tuning Fuzzy Logic System”) neither of which teachers multiple interactive for data mining over networks per se. Both of these documents are incorporated by reference. However, none of these multiple intelligence node systems is particularly well suited for use in a search processing system over the Internet to find relevant documents or pages.

### SUMMARY

The present invention provides solutions to the above-listed shortcomings by providing adaptive structures, such as fuzzy logic and genetic algorithms or modules to a neural network architecture in order to improve the capacity and trainability of the neural network for computing a relevant search result based on a large set of search criteria. By allowing the search criteria to be processed in a neural network, the system of the present invention can process information that would normally be too computationally complex to resolve.

The present invention is particularly effective at minimizing the organization and processing of massive amounts of data in order to find appropriate resources (i.e. documents or pages) in reponse for a search inquiry. One of the advantages of the present invention is that particular rules and application may be applied at several different levels to reduce the search and computing time. For example, the fuzzy neurode implements two complementary technologies at the lowest level and may prevent the processing of massive amounts of irrelevant information at the computational level. The adaptive genetic components may detect particular successful or unsuccessful searching configurations of the neural network and combine with other searching configurations where similar patterns have been detected. Finally, fuzzy logic and computation rules based on prior search results, user and situational data and manual or automated feedback mechanisms serve to teach the intelligence components of the present invention more efficient and accurate searching mechanisms.

### BRIEF DESCRIPTION OF THE DRAWINGS

The present invention can be better understood by the following diagrams and illustrations. However, as can be appreciated by those skilled in the art, the components of the present invention may be implemented in a variety of forms including virtual and physical as well as implementing what appear in the drawings as single units on multiple computing devices. Thus, the drawings are not meant to be limiting, but are provided for better understanding of the components and the interactions between the components.

FIGS. 1A-C represent prior art examples of search engine techniques on document scoring systems, document accesses or links.

FIG. 2 is a diagram of a prior art web crawling and data collection system that may be implemented by the present invention.

FIG. 3A depicts an overview of the present invention.

FIG. 3B represents the present invention, with a virtually duplicated data resource system.

FIG. 4 shows the representative connections between the data resource system and the search processing system.

FIG. 5 depicts the components of the search processing system.

FIG. 6 depicts the search processing system with user inputs and outputs.

FIG. 7 illustrates a conceptual model of the input system for an embodiment of the present invention.

FIG. 8 illustrates the components of the input system for an embodiment of the present invention.

FIG. 9 outlines a general method for operation of the present invention in a first embodiment.

FIG. 10 is a more detailed method of the implementation of the invention for generating a search processing result.

FIG. 11A is a simplified model of three inputs.

FIG. 11B shows a neurode input as a summation device.

FIG. 11C shows a neurode input as a logic gate and scoring device.

FIG. 11D shows a neurode acting as a threshold input device.

FIG. 12A illustrates details of a simplified input system as shown in FIG. 7

FIG. 12B illustrates the input system in FIG. 8 with the addition of fuzzy logic and rules application connections at the input level.

FIG. 13 illustrates a relationship between input and function levels in one embodiment of the invention in:which the neurode is configured by an expert rule or fuzzy logic such that it is a filter.

FIG. 14 illustrates a weighting of a neurode at the non-linear function or output level.

FIG. 15 illustrates a fuzzy connection at both the data input and function input levels.

FIG. 16 represents the method of applying a fuzzy logic at one or more levels in the neurally processed search.

FIG. 17 represents a function node with 6 binary input with 64 states.

FIG. 18 represents 4 input neurodes with 4 different types of inputs.

FIG. 19 represents a function node for processing 4 inputs of different types into standardized information inputs.

FIG. 20 represents the activation of the search processing system at high level by parametric or user data inputs by the expert rule module after processing input.

FIG. 21A is a sample search query activation of expert rules

FIG. 21B is a highly simplified portion of a lookup table used to define and implement rule systems

FIG. 21C is a lookup table used to activate a set of expert rules based on a search query in combination with user or parametric data.

FIG. 22 is an example of a method for training the search processing system, by recording and adjusting the fuzzy logic determination of the weights on the neural input.

FIG. 23 is an example in one embodiment of delivering a search result and a learning mechanism with the present invention in five sample stages.

FIG. 24A is a sample screen of a set of returned relevant results.

FIG. 24B is an example of training the invention through a feedback mechanism of recording users actions after returning a result.

FIG. 24C is a sample user survey to adjust expert rules.

FIG. 24D is an example of training the invention through an automated feedback review mechanism.

FIG. 25Ashows a genetic algorithm system as implemented in the present invention.

FIG. 25B depicts a modified algorithm being implemented by the expert rule module in response to an inadequate search return.

FIG. 25C shows and example of genetic algorithm recombination in the present invention in response to an inadequate search return.

FIG. 26 is a method for adapting and recombining a genetic algorithm.

FIG. 27 is a simplified example of the present invention adapting to change search techniques based on updated user and parametric data.

FIG. 28 is an example of multiple learning adjustments leading to an equilibrium for a document character. detector in a neural network.

FIG. 29 is an example of returning a search result by a pattern recognition computation technique.

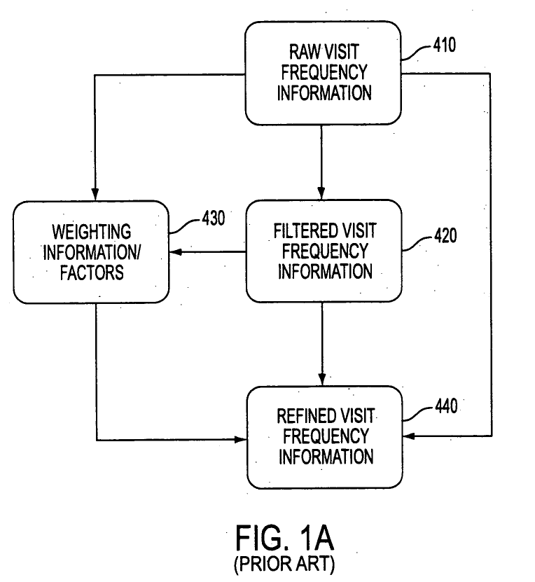

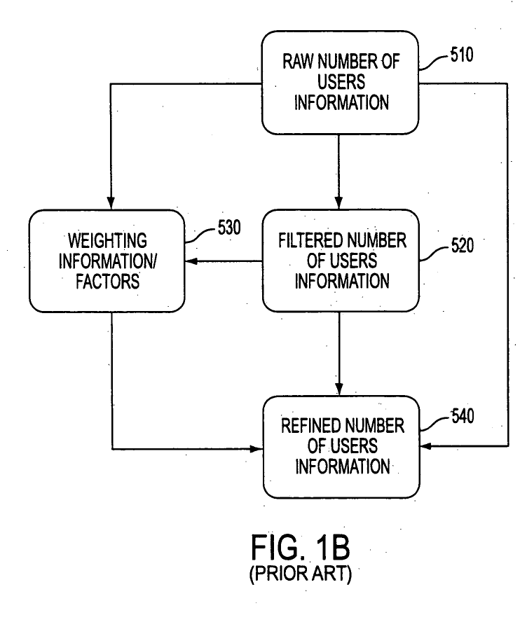

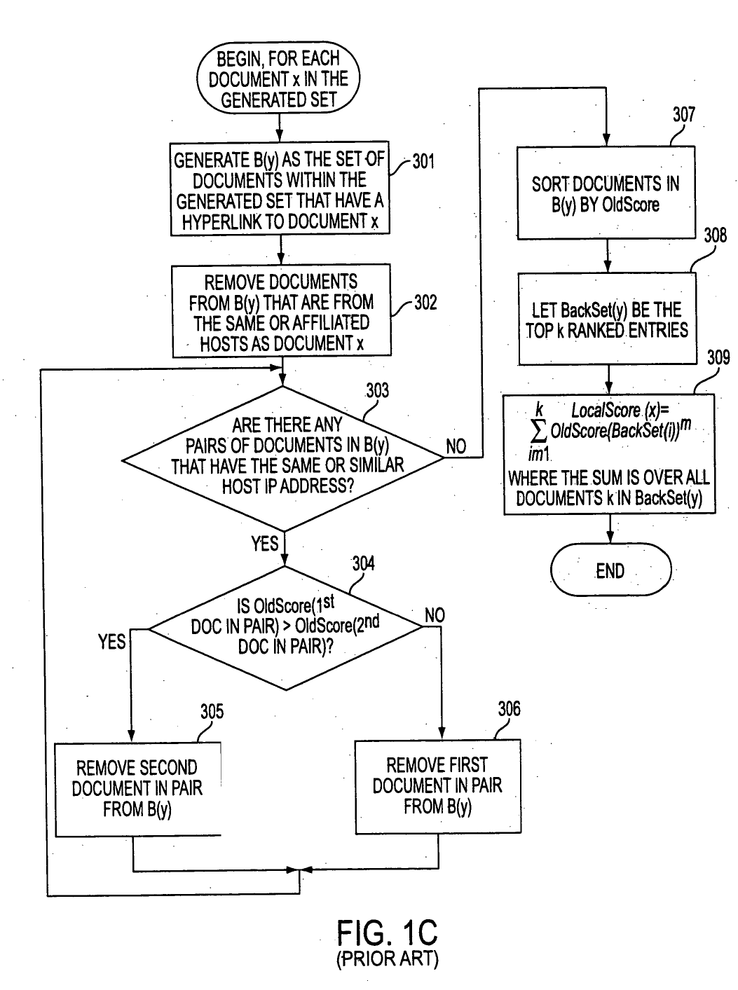

### DETAILED DESCRIPTION OF THE INVENTION

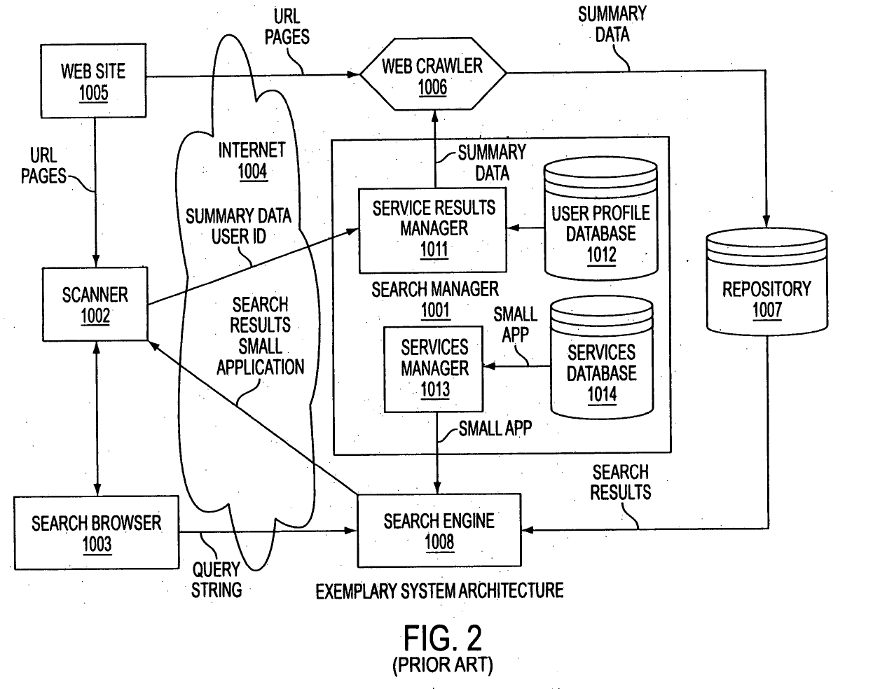

The present invention takes advantage of a virtual or actual neural network data searching system combined with the additional artificial techniques of using expert rules and fuzzy logic in search operations conducted over a large body of data collected from the Internet or other WAN. The present invention takes advantage of the power of the neural network in order to process higher level searching constructs instead of simple inputs. However, by processing data through a neural network on complex searching constructs, the system can provide many advantages in providing accuracy and customization. The present invention must be able to access a large pool of data collected from the Internet. Because these large pools of data are commercially available, it is expected that in a preferred embodiment of the invention that this data is purchased from a third party. Referring now to FIG. 2, a sample metadata collection system is shown.. The shown system and method involved in “crawling” through Internet servers for data is covered by several types of technologies, which for example, arebe included in U.S. Pat. No. 6,434,548 entitled “Distributed Metadata Searching System and Method” by Emens et al., and currently assigned to International Business Machines of Armonk, N.Y. This document is hereby incorporated by reference for all purposes. In an alternate embodiment, the present invention allows for the generation of pools of data by the search system. The advantage of generating the data within the system is that the data may be categorized in the most efficient manner to the user.

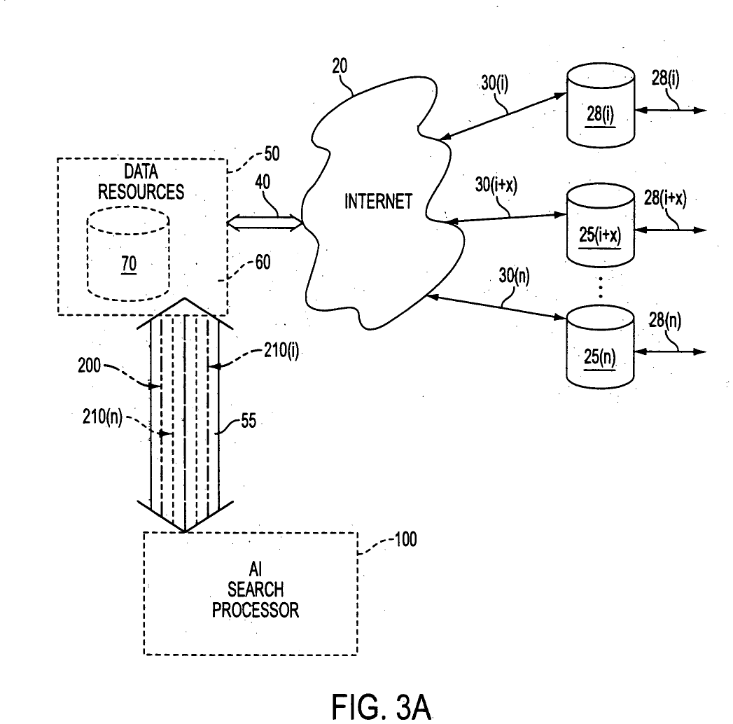

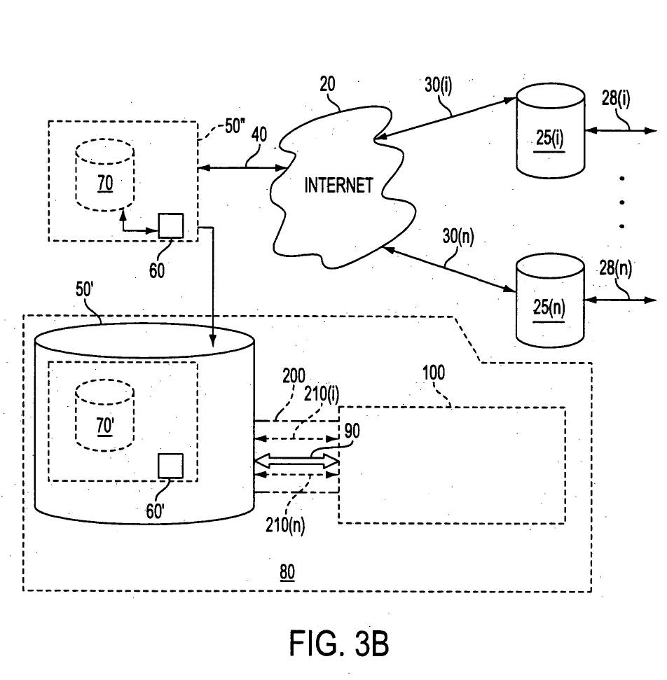

Referring now to FIG. 3A, a diagram of the invention is shown as it may be implemented in one embodiment for a system for intelligent searching of documents and URLs on the Internet. The search processing system may include or use a set of one or more Internet or Web servers 25(i). . .25(n) connected to the Internet or other WAN 20 via various communication channels 30(I). . . 30(n), which include T1, Ethernet, cable, phone and modem and other telecommunications protocols. The search processing system 10 may include or use a set of one or more “web crawler” and/or data resource module(s) 50. These data resource module(s) 50 include a crawling and/or processing unit 60 and data storage unit(s) 70 for massive amounts of data and generally enough computing resources to sort data from the crawler systems. TThese data resource module(s) 50 may be of the type described above and referred to in FIG. 2. Once again,. in a preferred embodiment of the invention the data is purchased from one or more vendors of amalgamated (and optionally categorized) web crawling data. These may include Inktomi, Google and other such vendors.

The data resource module(s) 50 are accessed by a search processing system 100 through a series of actual and virtual connections 55 which may be through any number of communications links such as T1, Ethernet, DSL, etc. However, in alternate embodiments of the invention, this access may be virtual where the data is simply duplicated in a more accessible location, such as where the search processing system 100 is located. The virtual duplication 50′ of the data resource module 50 in another location is shown in FIG. 3B. The advantage of the virtual duplication of the data resource module is that the connection for movement of massive amounts of data may be through an internal computer bus or other fast connection 90 instead of an external communications system 55, such as T1 or other virtual connection.

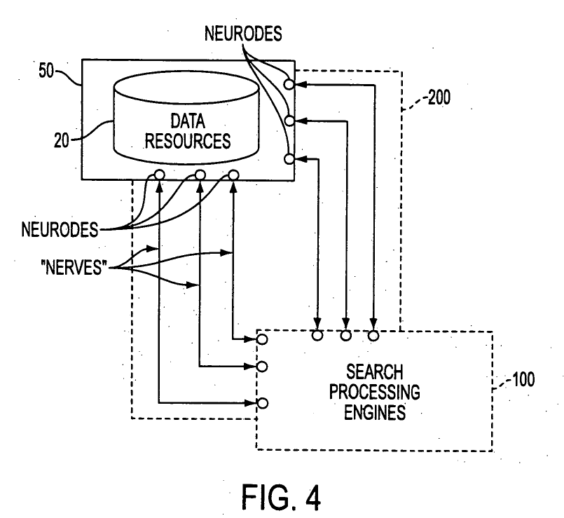

Referring now to FIG. 4, a detailed view is shown of the Multi modal AI search processor 100 (herein search processing system) connected to the data resource module(s) or collection system(s) 50. The data resouce module(s)50 has large amounts of document data stored on one or more large computer storage units 70. Connections 210(i). . . 210(n) may be virtual or physical in nature, but are represented as separate “nerves” in order to illustrate the computational architecture of the invention. The depiction of the group of connection of nerves 210(i). . . 210(n) is included in the “nerve sheath” 200.

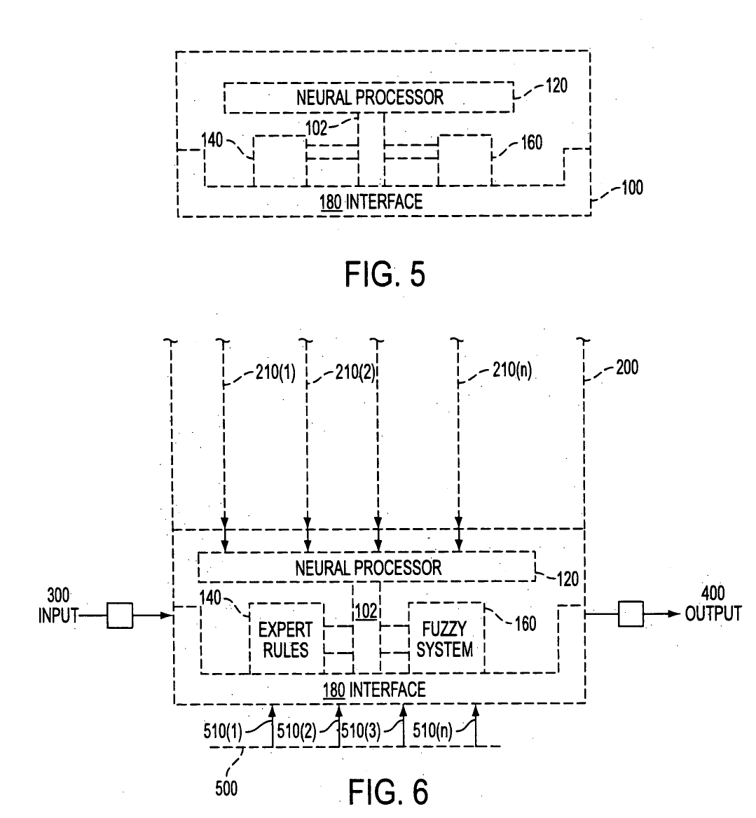

Referring now to FIG. 5, an intelligent search processing system 100 is shown. Virtual parts of the search processing system 100 include a neural network processor 120, an expert rules module 140, a fuzzy logic module 160 and an interface 180. The search processing system 100 generally is responsible for the computation of search results based on the input data.

The above structures are described as virtual structures even though they may be physically embodied in a specific device or in separate computer readable mediums. As can be appreciated by those skilled in the art, the modular descriptions of the various structures or components allow for an understanding of the computational architecture of one of the embodiments of the invention. Furthermore, there is no requirement that any one module be executed by a single computer or that all the modules be on the same computer. Neural network processing often benefits from parallel processing, which can include parallel processing on one device or multiple devices. In fact, throughout the specification the structures may be implemented in a virtual fashion. Those skilled in the art will readily recognize that there will be advantages to various implementations of the present invention. For the sake of simplicity, in a first embodiment and the examples illustrated all the modules will be located and executed on a single computational device.

Although it will not be discussed further, the components of the search processing system are stored and implemented on at least one computation device 102, which will most likely have storage or access to storage of a variety of different types. The details of the one or more computation device 102 on which the search processing system 100 is implemented are not particularly important to the present invention unless there are details which would affect the performance of many of the inventive steps and structure which are described below. It can be assumed that all the components of the search processing system 100 are executable on the one or more computational devices 102 and that data and instructions between components and modeules of the system 100 are shared through communication mechanisms included in the computational devices 102. These can be internal busses, external communication structures such as T1, Ethernet, wireless LAN, virtual data sharing, internal or external parameter passing in programming languages, access to a common internal or external databases among other communication and/or data sharing mechanisms.

Referring now to FIG. 6, a more detailed illustration of the intelligent search processing system 100 is shown in which internal and external data interacts with the search processing system 100. The search processing system 100 accesses parametric control data 510(i). . . 510(n) that is entered into or accessed by the search processing system 100 through an interface 180. The parametric control data 510 may be placed into the system by an administrator, or by a user of the system. Parametric control data may be stored and accessed by a control center in the interface 180, in another embodiment of the invention. An input search query 300 allows a user or another computer to enter a set of one or more search terms or criteria. The nerve sheath 200 including the individual “nerve connections” 210(i). . . 210(n) to the neural network processor 120 is shown a set of virtual connections. The search is “processed” by the three computation modules, the neural network processor 120, the expert rules module 140 and the fuzzy logic module 160, to give a search result through an output 400 connected to the interface 180.

As can be appreciated not all levels are necessary for the operation of the present invention. Although the collection of a large array of data allows the neural network to function optimally over the course of a large number of searches, in addition to developing learning rules which may apply at both low and high levels.

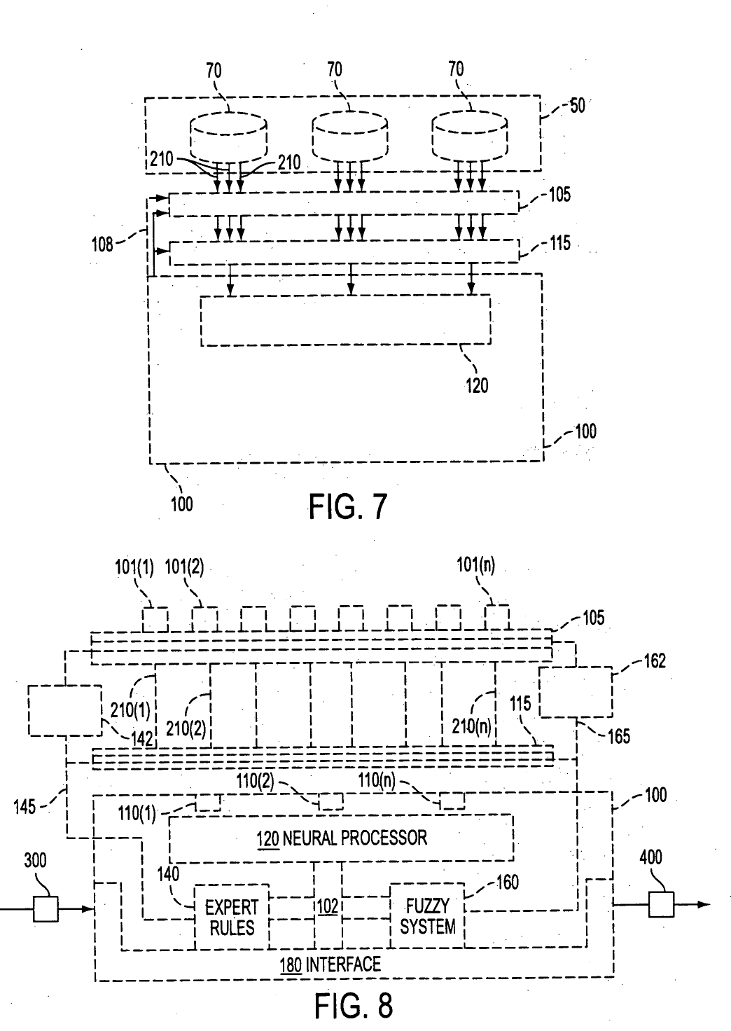

FIG. 7 depicts the general operational and structural concepts of the present invention. The search processing system 100 receives data from a set of low-level input nodes 105 via the function (nonlinear in most embodiments) nodes 115. The search processing system provides feedback via a feedback mechanism 102 to both the data input level 105 and function processing level 115 in order to effectively regulate the data searching system. These two levels, 105 and 115, are shown because of the potential benefit of using multiple levels of neural input for organizational purposes. However, these levels may be collapsed in a particular embodiment of the invention where there is no need for multi-level processing. However, levels 105 and 115 are shown for clarification purposes only and may be one and the same in some embodiments.

FIG. 8 shows a more detailed aspect of a particular embodiment of the invention. The “nerve sheath” 200 includes one or more neurode inputs 101(i). . . 101(n) connected to an neural network node or function gate outputs 110(i). . . 110(n) through a connection or axon 210(i). . . 210(n). These structures are shown to be virtual as they may be implemented either virtually through software or implemented in various other software and hardware embodiments. For example, the neurode inputs 101(i). . . 101(n) may be an executable program used by the search processing system 100 to gather information from the data collection system 50, but be connected through a single telecommunication connection 200, such as Ethernet. The information may be passed to the search system. 100 through one data packet or a stream of packets as may be appreciated by those skilled in the art, while the individual data used by each neurode input 101(i). . . 101(n) is processed by the appropriate neurode.

Similarly the neural network nodes 110(l). . . 110(n) receive the appropriate information from the weighted neurode or set of neurodes via an “axon” even though the nodes 110(n) may be part of the same executable instructions as the neurodes 101(n) which gather the data. The discrete nature of these structures is useful in implementing the multiple AI processes involved in the present invention as may be appreciated by those skilled in the art.

FIG. 8 details the invention with the implementation of the AI search modules, the expert rules module 140 and the fuzzy logic module 160. The fizzy logic module 160 may be connected to the neurode inputs 101(n) and/or the network function gates 110(n) through a virtual or real connection 165 and a fuzzy logic implementation module. Similarly, the expert rules module 140 is connected to the multiple levels of input processing through virtual connection 145 and controlled by virtual rule application device 142 when appropriate rules have been activated.

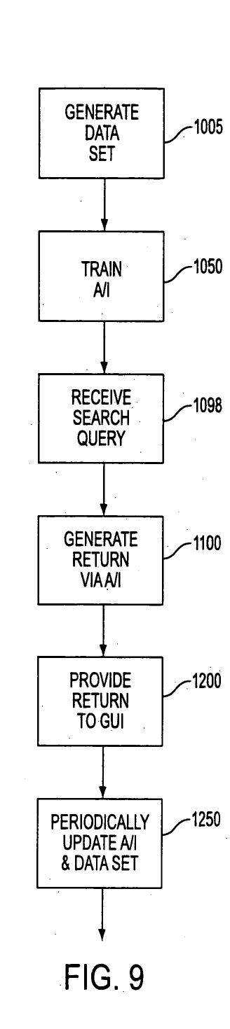

Referring now to FIG. 9 a general basic operation 1000 of the invention in the particular embodiment is described. Step 1005 results in the generation of a data set relevant to search queries. FIGS. 2 and 3 describe the generation of the data set through the collection of data from the Internet 20. The data set may be stored on the data resources devices 50, 50′. The data may also be used to train various levels of the artificial intelligence modules in the search processing system 100 in step 1010. However, other resources are used to train the search processing system beyond collected data. The specifics of the training will be described below. In step 1050 the search processing system 100 receives an input search query 300 through an interface 180 and generates a result via the AI in the search processor 100 in step 1100. The generated result is returned to the user via output 400 in step 1190 and rules and heuristics in the AI data set and processes are then updated on a periodic (regular or special event) or real time basis in step 1200. The updated processes will also be described below.

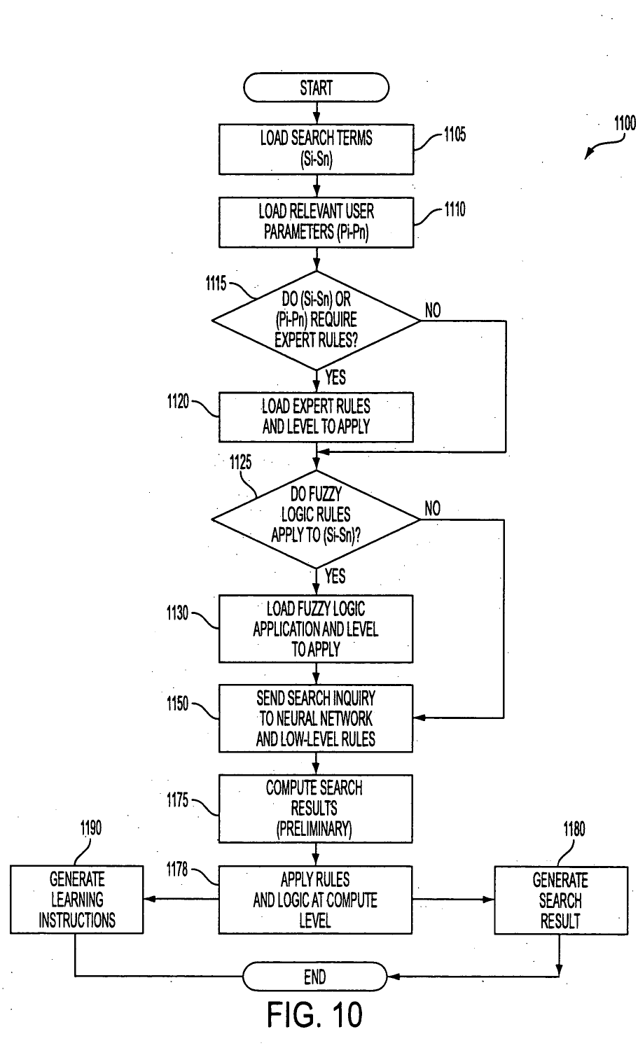

FIG. 10—shows the basic steps in the generation of a search result 1100 through the search processing system 100. Step 1105 requires the loading of the search terms into the search processor 100. At step 1110 the relevant parameters (discussed above) are loaded into the search processor 100 if they have not been already loaded. At step 1115, it is determined whether either the discernable search terms (S(i)-S(n)) or parameters (P(i)-P(n)) require the application of special expert rules included in the expert rule module 140. If so, the appropriate expert rules are loaded and applied at the correct level in step 1120. In step 1125 it is determined whether fuzzy logic applies at any level to the search criteria or the parametric data. However, it is anticipated that the fuzzy logic rules will have already been set to the relevant parametric data if they have been previously accessed. If fuzzy logic rules apply to the search or parametric data, then the rules are loaded into the appropriate level where they are to be applied.

The relevant preliminary search result is then generated in step 1175 from the neural network 120, which receives data from (or has already “learned” from) the low-level level neural input in step 1150. The preliminary search result is subject to a high-level modification from the expert rule 140 and fuzzy logic 160 modules in step 1178. In step 1180 the search results are delivered to the user through the interface 180. Simultaneously, any data for learning instructions is generated in step 1190. Learning by the search processor 100 is described in detail below. It is anticipated that step 1178 will become decreasingly necessary for each time the learning instructions are generated in step 1190. The application of expert rules and fuzzy logic at the low level in step 1150 saves considerable computational resources over applying them at higher levels. The process of generating a search result is described below, but as can be appreciated by those skilled in the art, may be executed in many different ways without departing from the spirit and scope of invention.

Parametric control (including user) data 510(i). . . 510(n) will generally be macro level data that defines the behavior of the entire search engine. The parametric data may be based on an individual user's preferences or conditions that may be easily determined by the interface 180. This data may include items entered by the user such as financial situation, content preferences, geographic location, etc. Automatic parametric data may include weather, stock market results, the particular user of the interface, detected inquiries to the user's credit card and any number of variables which may influence the manner in which the search may be conducted. The table below helps define one aspect of the present invention.

TABLE 1.1
Sample characteristics for generating neural responses

| | Neural Input | |
|---|---|---|
| # | Human Review | Automated Spider Review |
| 1 | | TLD |
| 2 | Commerce | IP Geography matches users Geography |
| 3 | Geographically | User previously selected |
| | relevant | |
| 4 | Authoritative Site | Average time between clicks |
| 5 | Design Quality | Domain Name contains Keywords |
| 6 | Extraspecial status | Meta Description contains keywords |
| 7 | Ads present | Meta Keywords contains keywords |
| 8 | Porno | Title Tag contains keywords |
| 9 | Gambling | Alt Tag contains keywords |
| 10 | Profanity used | Static/Dynamic IP |
| 11 | Family safe | Keyword Density |
| 12 | Overall weight add | Absolute Keyword Number |
| 13 | | Feedback Score |
| 14 | | Privacy Link |
| 15 | | Paid Inclusion |
| 16 | | Link Popularity |
| 17 | | DNS is correct |
| 18 | | 404s exist |
| 19 | | Pop up windows exist |
| 20 | | Flash present |
| 21 | | Php |
| 22 | | Asp |
| 23 | | Cfm |
| 24 | | last refresh of page |
| 25 | | Top ten at Dmoz |
| 26 | | Top ten at Zeal |
| 27 | | meta refresh exists |
| 28 | | https |
| 29 | | Header text keywords |
| 30 | | Average number user selects commerce sites |
| 31 | | |
| 32 | | Fortune 500 |
| 33 | | Fortune 1000 |
| 34 | | Average page load time |
| 35 | | Christmas |
| 36 | | Valentines day |
| 37 | | Easter |
| 38 | | Hanukah |
| 39 | | New Years |
| 40 | | Winter |
| 41 | | Summer |
| 42 | | Autumn |
| 43 | | Spring |
| 44 | | tax day |
| 45 | | # clicks from unique lps |
| 46 | | Hour of day |
| 47 | | Originating IP is home or business |
| 48 | | Porno |
| 49 | | Gambling |
| 50 | | Profanity used |
| 51 | | Family safe |
| 52 | | Multiple clicks from same user by cookie |
| 53 | | Multiple clicks from same user by IP |

The “spider review” shown above is then an effective way to describe a summary for samples of the “neural input” for the present invention. However, the list in the above table is by no means exhaustive, but meant to be illustrative only. As can be appreciated by those skilled in the art, the advantage of using a neural network to get data at such a low level is in representing fairly complicated search constructs in a large number of standardized, normalized or standardizable data inputs for processing. In the table above there at least 53 spider nerve inputs and 12 human review inputs.

Human review input, such as design quality and content issues that may be computationally difficult to calculate from the neural network may be stored as data in each of the modules. As more data is generated by the search processing system 100, the computer will be able to apply the human rules to its own learning generated from the data and will also learn other rules on its own. For example, a pattern recognition algorithm may apply to a URL with a large amount of pop-up advertising although undetectable by the search system 100. The common characteristics or “neural patterns” from the spider review will alert the system that such patterns correspond to the same one as the human-reviewed URL with a large amount of advertising.

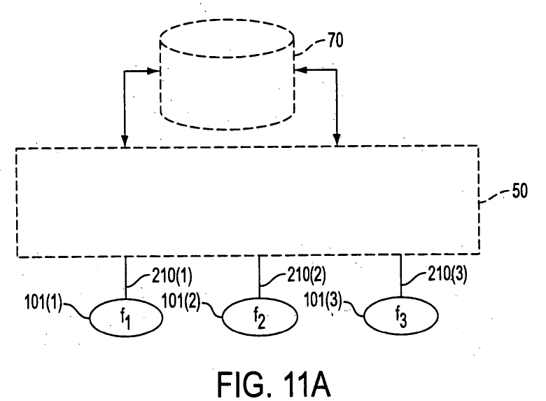

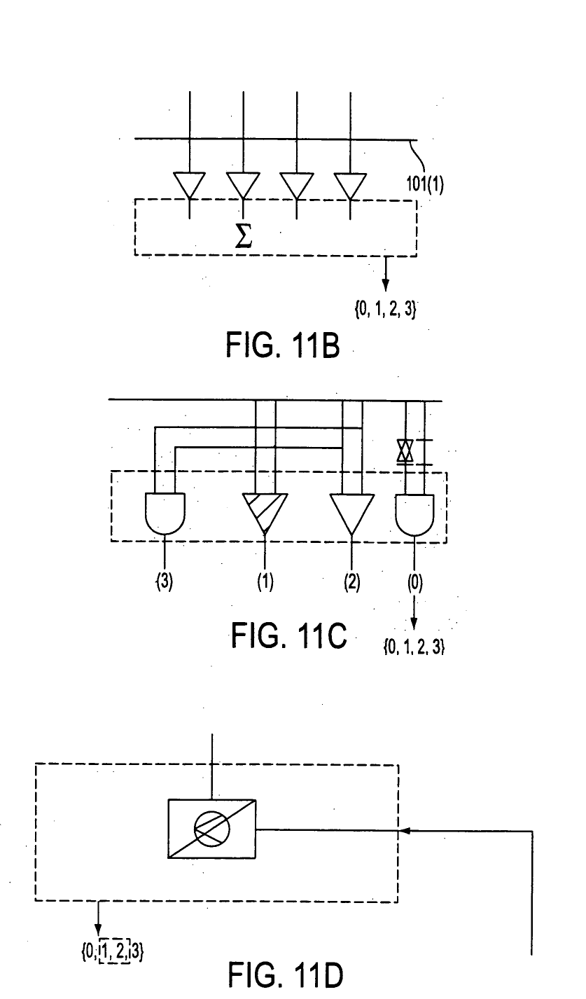

FIGS. 11A-D show the functions of the neurodes at the data input level or neurode level 105. FIG. 11A is a simple representation of three input neurode reponding to three different data characteristics. FIGS. 11B and 11C represent more detailed representation of two simple neurode data input devices as would be used in the present invention. FIG. 11B shows a neurode 101(l) that inputs a “top level domain” (TLD) stimulus according the level from the TLD name. For example for each level down the domain the neurode classifies 1 higher. Thus, .com is 1 com/bookmark is 2, .com/bookmark/subdir is 3, etc. The output signal (described below) can be in different formats and still be processed at the function 115 or computational 120 levels. However, the more uniform the inputs the less computational resources will be taxed.

FIG. 11C shows another simple input for at the neurode low level as a simple function of logic characteristics of the data. Neurode 101(2) measures a “match” aspect of the search inquiry, such that the more “words” that match those with the data the stronger the input signal. FIG. 11D is another example in which a threshold or screening function occurs at input or output to the neural network processor 120.

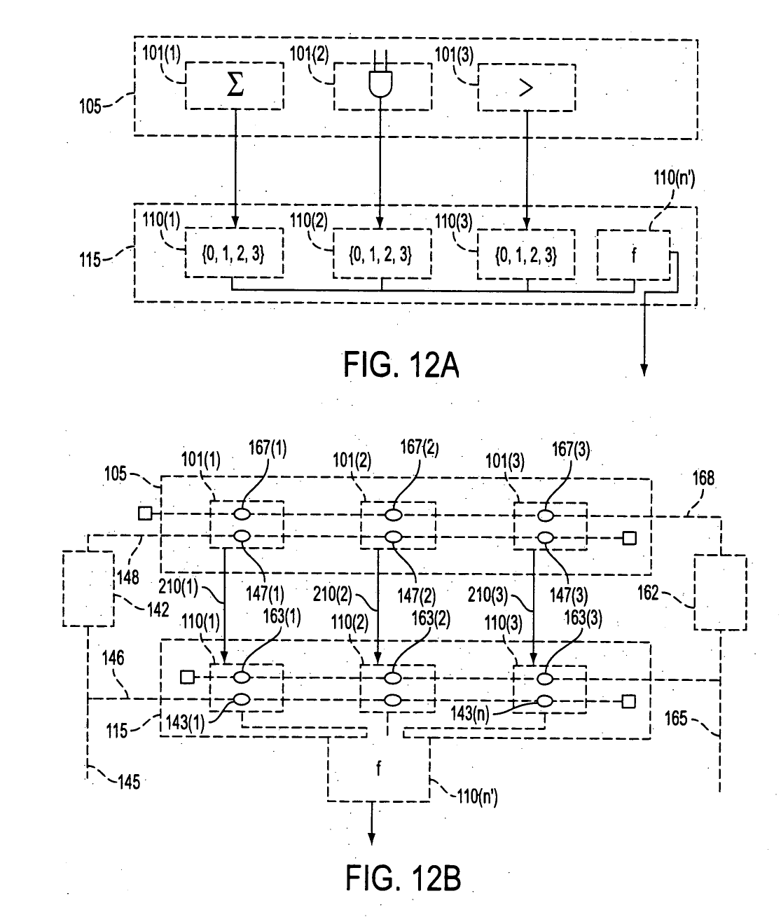

FIG. 12A illustrates how standardized neurode input may be standardized for processing by the neural network processor 120. The data is collected in the individual neurodes 101(1), 101(2) and 101(3). The neurodes 101(n) may conduct a low-level filtering, screening or processing as shown in FIGS. 11B-D, but also may have a standardized or normalized output for processing purposes. The standardized or normalized output may occur at the low level 105, or the function processing level 115 or at the neural network processor 120. The function processing level may serve as a “boundary” or non-linear function through individual processors 110(n,).

The general process of providing feedback through the expert rules module 140 or the fuzzy logic module 160 is shown in FIG. 12B. This embodiment depicts how the present invention can learn at the various processing levels to more effectively conduct a search, thus better learning how to process a search. The optional fuzzy logic translator 162 acts as a translator between the fuzzy logic module and the individual neurode 101(n) or function 101(n) inputs. The effect of the fuzzy logic translation on individual neurodes 101(n) is depicted by weight 167(n). The application of expert rules from the expert rule module 140 is applied in the same manner by input rule 147(n) or output rule143(n) applicators.

In FIGS. 12B. 13-15 three different types of neurodes process individual components of the “spider review,” which results in standardized input for the network processor 120. In the illustrated example, each of the inputs is standardized to one input of set {0,1,2,3} and as such will be easy for the neural network 120 to process. The function processing inputs thus will have an input which can be processed.

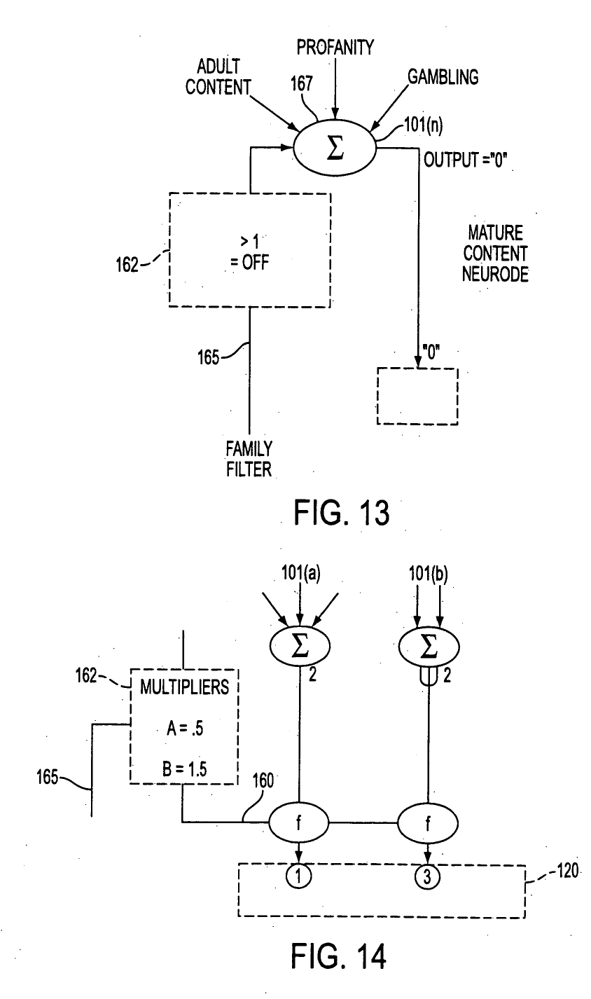

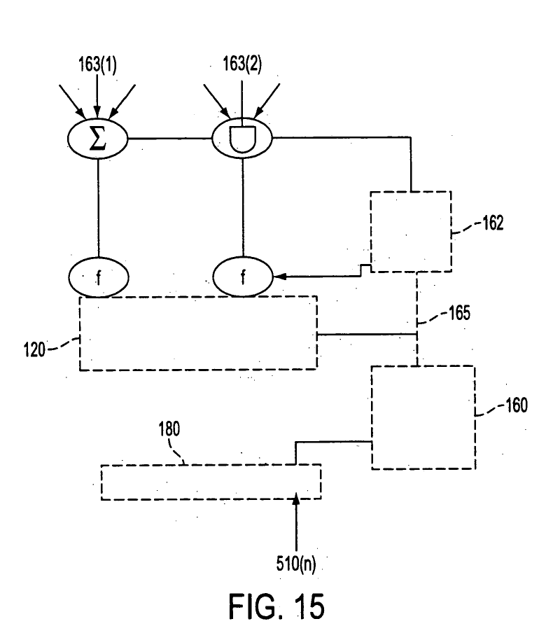

FIG. 13 represents an individual example of weighting/influencing at the individual neurode level through the weighting connections 167(n). Similarly FIG. 14 represents weighting at the function gate level 163(n). FIG. 15 depicts weighting at both the neurode 101(n) and function gate 110(n). As can be appreciated by those skilled in the art, there are many variations on the type of input and output screening, weighting. and application of functions which would be appropriate for providing different types of input. However, the main thrust of the providing low-level computing is to both save resources in compiling analysis on a large pool of data and continually improving the low level “intelligence” capabilities.

As can be appreciated by those skilled in the art, FIGS. 13-15 represent various types of fuzzy neurodes as they may be implemented into the system of the present invention. The implementation of such specially adapted neurodes may save significant computational resources by implementing simple rules (for set inclusion mainly) at the low level inputs. However, since these structures are virtual, the computation needed to implement fuzzy logic rules for simple inputs may be executed by any number of computational devices or by a single computational device.

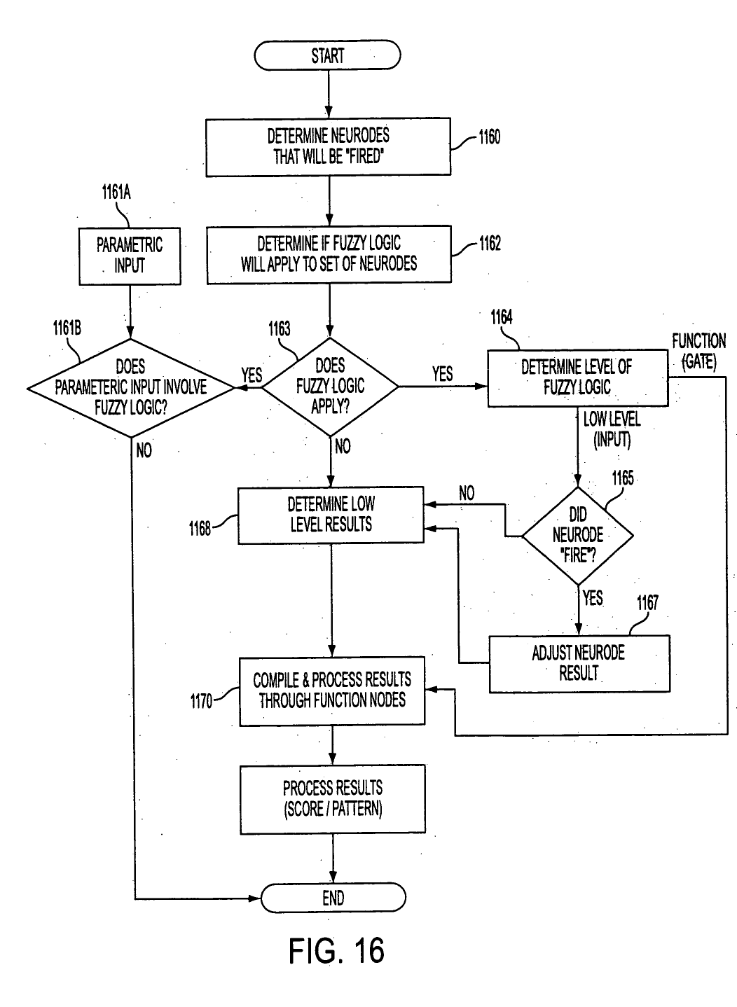

FIG. 16 represents a simplified method 1160 for conducting a search in which the fuzzy logic is implemented at the input level 105 at the neurodes 101(n). If the fuzzy logic applies to particular neurodes for parametric inputs, then the fuzzy logic module sends a signal to the input level 105 of the neurodes or the function gate level 115 to adjust the weights accordingly. For example, if the parametric input is good market conditions, the neurodes for higher risk investment opportunities (less reputation+investment, etc.) may be weighted more heavily and result in a match. Of course the search processor can learn from more than parametric inputs as it learns many other rules from the human input matching, feedback provided by humans, human actions and machine learning. Furthermore, expert rules may always override any fuzzy logic inputs when any appropriate conditions are met.

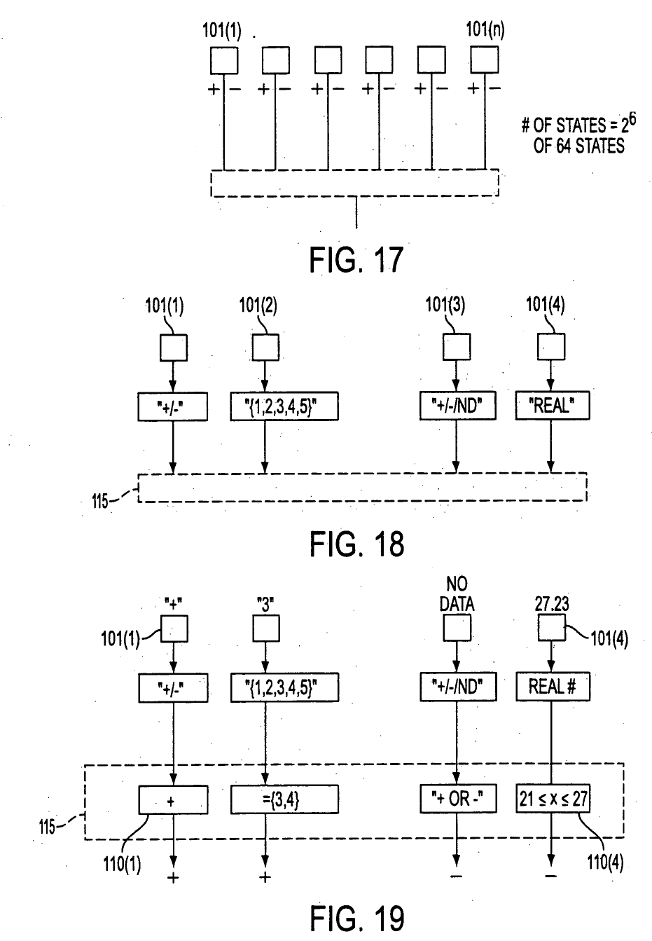

FIGS. 17-19 represent sample processing of states of neurode in various embodiments of the present invention. FIG. 17 shows the number of “states” which are computed in a neural network processor 120. These states may be used in the any computation in returning a search result. Thus 6 on/off inputs will give the neural processor 64 states computation. FIG. 18 depicts a collection function neurode 110(n) that collects multiple input types which may or may not be compatible. The multiple types of inputs can be standardized and/or normalized for neural processing. FIG. 19 depicts the standardization of multiple neurode 101(1′). . . 101(n′) input types which are then processed in common binary inputs by non-linear processors at the function inputs 110(1′). . . 110(4′) such that they are standardized into a value of“+” or “−”. The neural network processor can handle many data types such sets, numeric, strings, Booleans, etc. However, the standardization of input to the neural processor 120 is one manner in which the relevance determination may be advantageously computed in a particular embodiment.

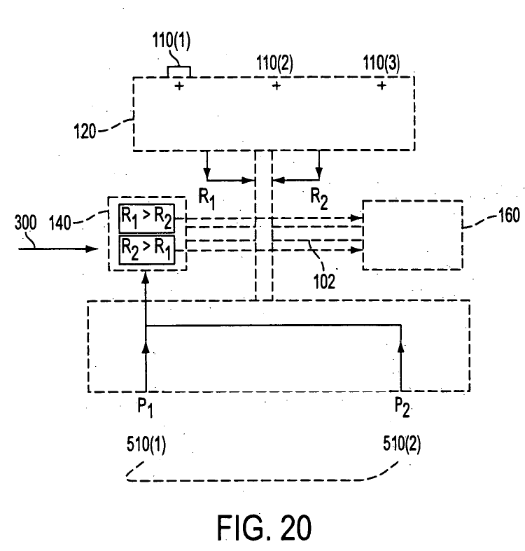

FIG. 20 shows how the parametric input 510(1), 510(2) may function at the “cortex” level to train the neural network processor 120. The advantage of the fuzzy neural input is that computation is reduced by applying the computation at a low level as well as having the ability to apply fuzzy at a high level, for example after the search query 300 is entered into the interface 180, parametric data 510(1), 510(2) applies a rulein the expert rule module 140 such that if a preliminary answer is provided by the neural network processor 120 such that R(1)>R(2) a set of fuzzy logic rules, W(x,y) will apply to a high level fuzzy logic adjustment of the preliminary search result. If a preliminary answer is R(1)<R(2) a second set of rules W(x′,y′) may optionally be applied in the fuzzy logic module 160. However as can be appreciated by those skilled in the art, parameters may or may not need to be relevant in all cases, the network accommodates this and determines predictability in a massively parallel distribution of search knowledge. In such a case where a parametric or user data is not initially deemed to be relevant the search processing ignores one or more pieces of parametric data 510(n) based on search criteria and applied rules in the expert rule module 140. This acts as a pre-search fuzzy set, i.e. the set of parameters used in the search is limited by the “category” of the search.

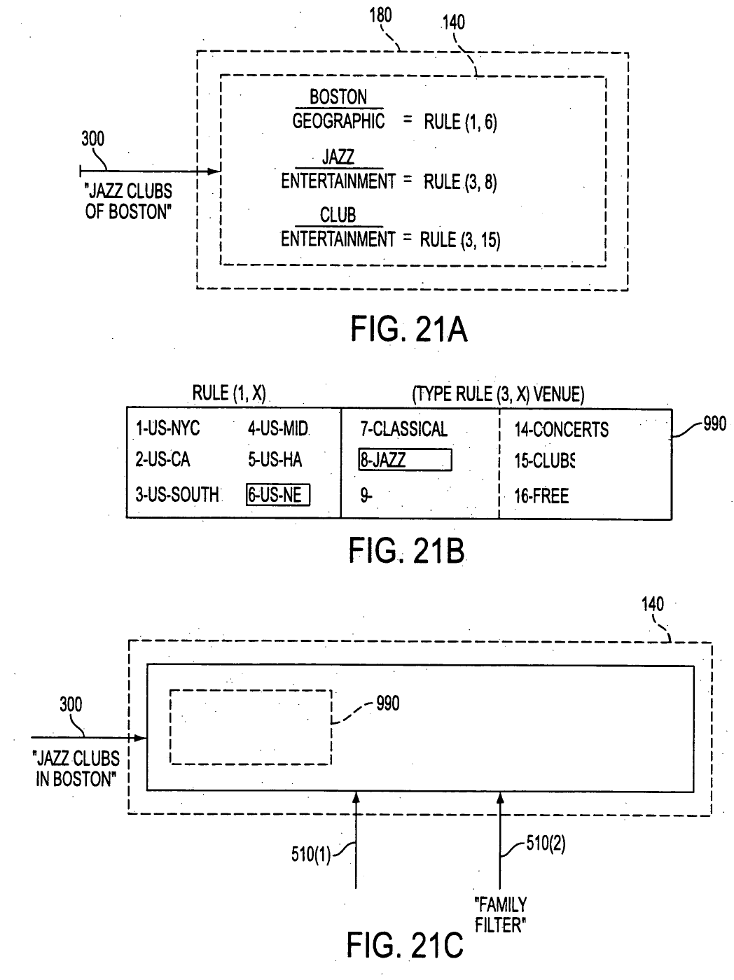

However, as can be appreciated by those skilled in the art, even 20 or 30 neural input parameters with 3 states each may quickly become unmanageable computationally complex and inaccessible. The advantage of the fuzzy logic being located at the neural input 101(n) or 110(n) is processed is that control over the computational aspects of potentially massive amounts of input data. Search inputs 300 which is particularly sensitive to certain parameters 510(n) can be adapted to become a fuzzy neurode, instead of the neuro-fuzzy processors. The process of applying a set of expert rules in the expert rule module 140 is shown by FIG. 21A-C. The search “jazz clubs in boston” is entered in FIG. 21A rules in three expert rules applying from the results in a simple rule lookup on a two (or greater) dimensional table 990 in FIG. 21B. There may be hundreds of multi-demensional tables 990(i). . . 990(n) stored physically or virtually. FIG. 21C depicts how user or parametric data 510(n) affects the rule lookup.

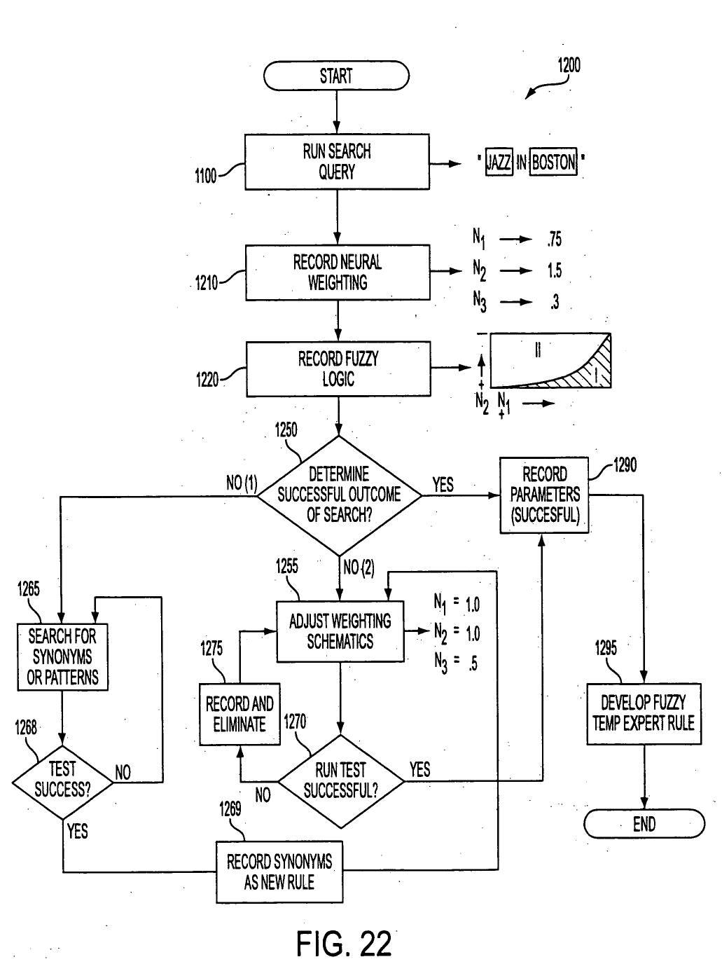

Referring now to FIG. 22 a flow chart that describes the machine learning process 1200 of the search processing system 100 to a learned rule for improving the searching technique. After the search query is run in step 1100, the fuzzy logic weight assignments for inputs are recorded.

The neural network processor 120 allows for the inclusion of personal data in the decision process like previous consumer behavior to add predictive ability to what a relevant search return would be. The personalization of the personal data for determining relevancy is a key enhancement compared to current art, which for the most part return globally relevant returns and acts to enhance the machine intelligence self-training. For example, a person in China searches for Soy Sauce and a Restaurateur in Manhattan searches for Soy Sauce. The returns will be quite different because the search processing system 100 via the neural network 120 recognizes important determinants of relevancy for each individual searcher from the application of the expert rules based on these parameters. As stated above, the effect of thee personal and parametric data 510(n) may be processed at multiple levels either directly the neural network “neurodes” (low-level), the function gates (mid-level), or post neural processing (high-level). Thus, in the above example, items in the neural network which respond to the “geographic” neurode, which would be “reweighted” based on personal geography, for a low-level implementation.

TABLE 1.2
Sample Expert rules applied at low or high levels
Expert Rules

match existing domain name?
commerce keyword appears
geographical keyword appears
exact match to human review keyword

The search processing system 100 of the e present invention is melded with human review, spiders, genetic (sub)algorithms, fuzzy inference engines and expert systems which are comprised of sets of adaptable expert rules. The sets of rules applied by the expert rule module 140 may be preliminary global rules which are rules that are still being adapted. There may also be global rules which are rules which are the product of many adaptations and have been tested. Expert rules or subsystems may be implemented at multiple levels. An example of this is where an expert (sub)system determines the presence of documents which result in spam. Anti-spam parameter 510(n) will resulting the expert system being loaded into the fuzzy logic module and applied at a low-level input so that data on documents which results in spam is not processed by the search engine at the neural network level.

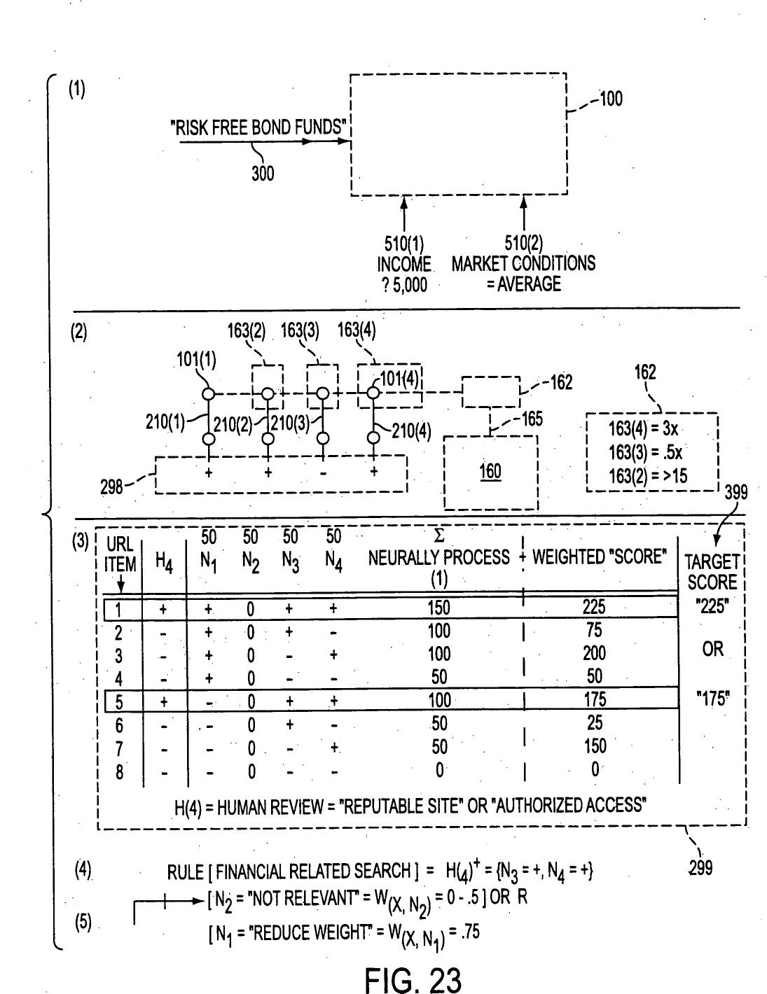

FIG. 23 depicts one system for determining an appropriate match or document based on the scoring. In part 1, a user inputs the search inquiry “risk free bond funds” search inquiry 300 is placed into the search engine interface 180. The preloaded parameters 510(1) and 510(2) include market conditions (“average”) and current income (“$75,000”).

In part 2, the fuzzy logic module sends weighing instructions to neurode inputs N(1)-N(4) either based on instructions from the search engine or the relevant parameters 510(1) and 510(2). Of course, the search system 100 could associate the two parameters 510(1), 510(2) (market conditions and income) with search inquiry terms “risk-free” and “bond” or “funds.” As can be appreciated by those skilled in the art, association of information may lead to reduced processing time by eliminating nodal information that may not be particularly relevant. For example, in the automated spider review in Table 1.1, holiday input may not be particularly weighted with importance while searching for financial services (on the other hand, the expression Easter may be related to tax season).

In part 3 documents are compared to an itemized truth table with scoring 299 from a previous search which is further put together with relevant human input data for category H(4), that is a “reputable or authoritative site” (see Table 1.1 below) in this example. Thus, the summation or weighted scoring may be one mechanism to determine appropriate search results, but the H(4) criteria in this case overrides the scoring and will not allow for high scoring matches which are not authoritative. Thus, a “target score” match 399 is made by the machine learning mechanism and noted for fixture use of “225” or “175” but not the “200” score. Furthermore, from part 3, the machine learns that H(4) is generally present when N(3) and N(4) signals are present, but N(1) appears to be less relevant and no positive N(2) data was returned which met the threshold condition. The search results may be presented to the user by high score and reputability in Part 4. However, in part 4, the search processing system “learns” that neurode input N(3) and N(4) are likely indicators of this human input attribute H(4) and adapts such learning for the next appropriate search task and a preliminary global rule may be put into the expert rule module 140. In step 5, for the next search of the type the presence of N(3) and N(4) will be give larger weights or N(1) may also be reduced in weight. Thus repeated learning of this type will nearly eliminate N(1) as relevant. However, the system eliminates N(2) from the neural connection for the next search of this type.

TABLE 1.2
Human Review Input

| # | Human Review | Expert Rules |
|---|---|---|
| 1 | | match existing |
| | | domain name? |
| 2 | Commerce | commerce keyword |
| | | appears |
| 3 | Geographically | geographical |
| | relevant | keyword appears |
| 4 | Authoritative Site | exact match to |
| | | human review |
| | | keyword |
| 5 | Design Quality | |
| 6 | Extraspecial status | |
| 7 | Ads present | |
| 8 | Porno | |
| 9 | Gambling | |
| 10 | Profanity used | |
| 11 | Family safe | |
| 12 | Overall weight add | |

The above table is illustrative of the human input and expert rules as implemented in the present invention in a particular embodiment. These are only illustrative to the example. The expert rules are nonflexible during an intrasearch criteria applicable to the computation of the neural input although these expert rules may be detected at the input node 105 or function gate level 115 as well. However, as shown above, the expert rules are clearly adaptable in the machine learning system of the invention.

TABLE 1.3
Sample high-level fuzzy inferences

Fuzzy Inference

| mild | moderate | severe | Comment |
|---|---|---|---|
| cool | warm | | |
| good | fair | bad | |
| small | Big | | |
| close | Far | | |
| short | Long | | |

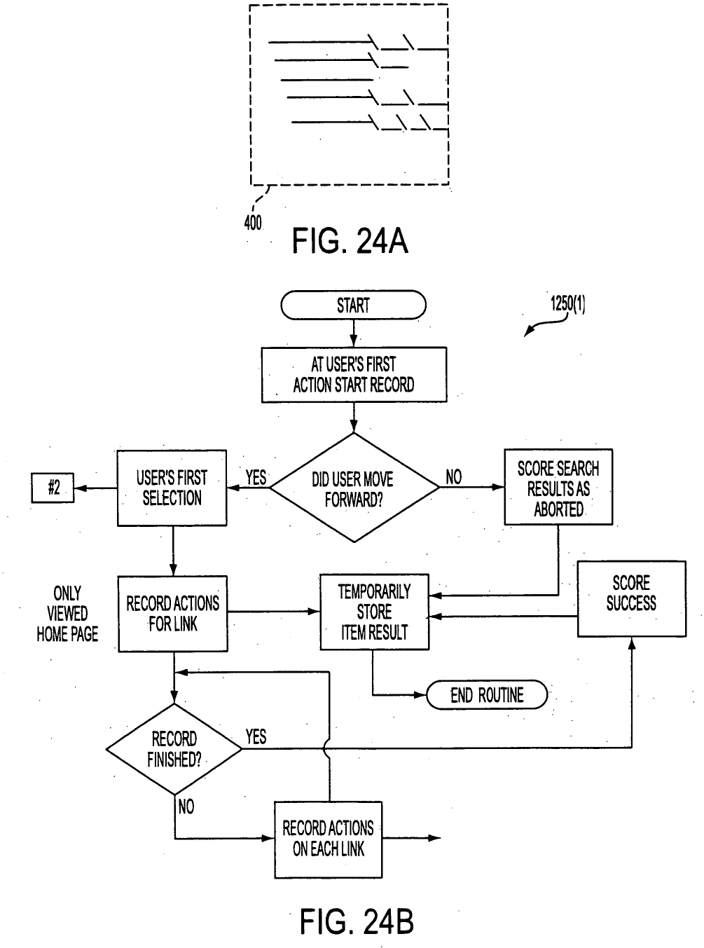

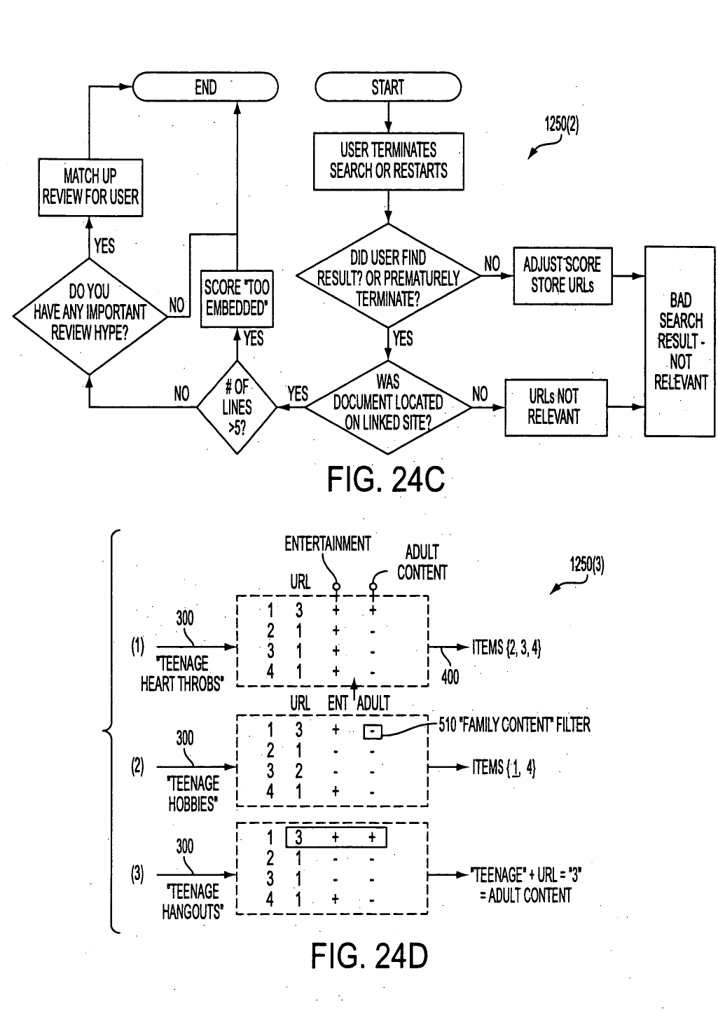

FIG. 24A-D show sample feedback mechanisms for learning. FIG. 24A is a sample screen of five returned search results with different level of domain accessibility. FIG. 24B is a sample tracking method 1250(1) for learning from the behavior of a user after the search result in FIG. 24A is provided. In essence the search processor 100 temporarily stores the results and compares the users behavior. Thus, if a user always chose the selection with a top level domain, the system 100 would learn that the TLD score must be increased in weight for each search.

Similarly in FIG. 24C the user provides simple feedback after the search and the results are processed by the learning system for an application to the expert rule module

In FIG. 24D, an automated machine learning mechanism is shown. In this scenario, the search expression “teenage” is used by a 13 year old to find relevant documents on “heartthrobs,” “hobbies” and “hangouts.” The filter for adult content is always on when this user is present. However, in part 2, the search processing system did not return an adult flag for “hobbies.” By part 3, the computer has learned that adult sites which key to the word “teenage” bury their documents 3 pages deep. Thus, in part 3, albeit too late for part 2, the machine “learns” that a score of “3” on the domain level, necessitates a flag for adult content, block those pages. Thus, if part 2 happens after part 3 then no adult content is returned.

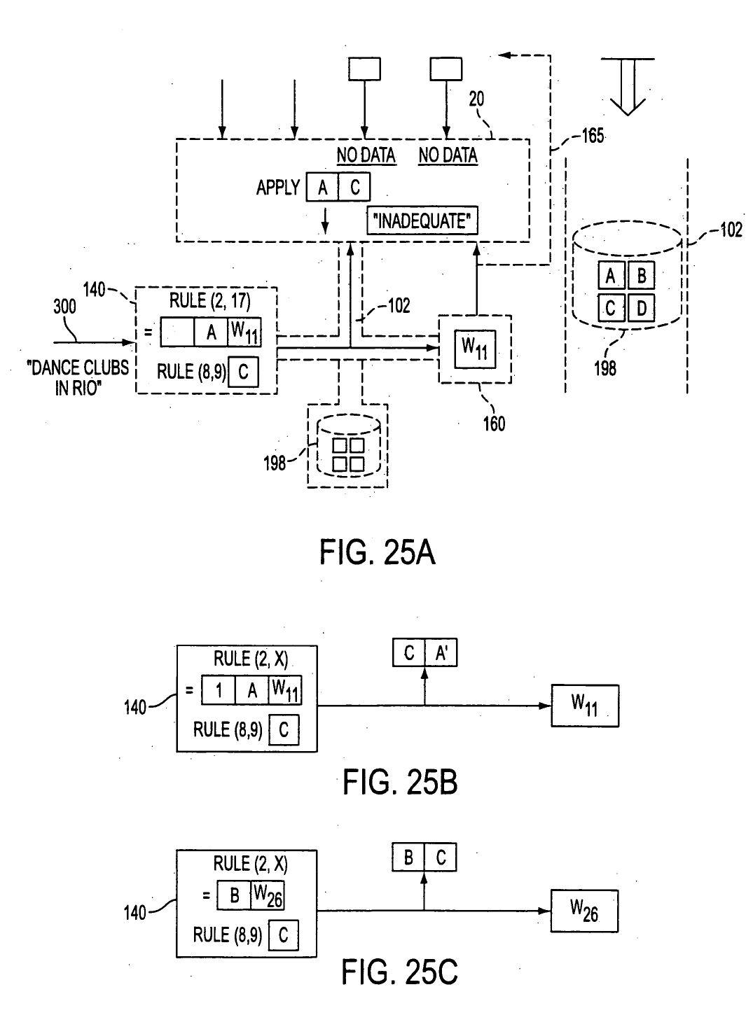

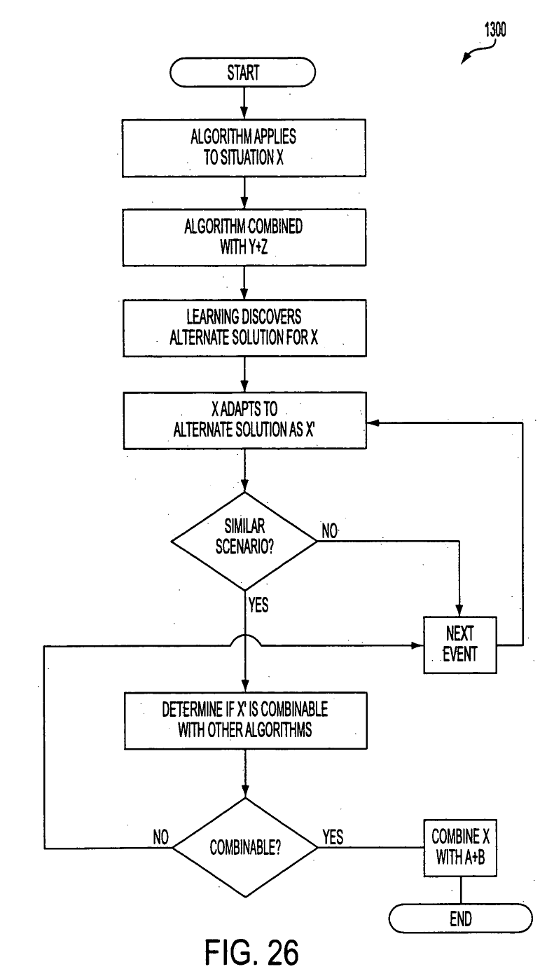

FIG. 25A-C are illustrative of a simple examples genetic algorithms as they may be adapted or combined as the result of machine learning. These algorithms may be global to the whole search system 100 or used only by one component. They are virtually stored in virtual storage 198 on one or more computing machines 102, such that they may be accessed by any component of the search system 100. FIG. 25A illustrates and inadequate search for “dance clubs in rio” which resulted in the application of algorithms A and C in the neural processor 120 and weighting rule W(1,1) in the fuzzy logic module 160. FIG. 25B shows the expert module 140 adapting A to A′ and storing it for use with C for the retry search. FIG. 25C shows expert rule module combining B with C in the neural network processor 120 and applying adapted weight rule W(1,1′). FIG. 26 simply illustrates a method 1300 for applying the principles shown in FIGS. 25A-C.

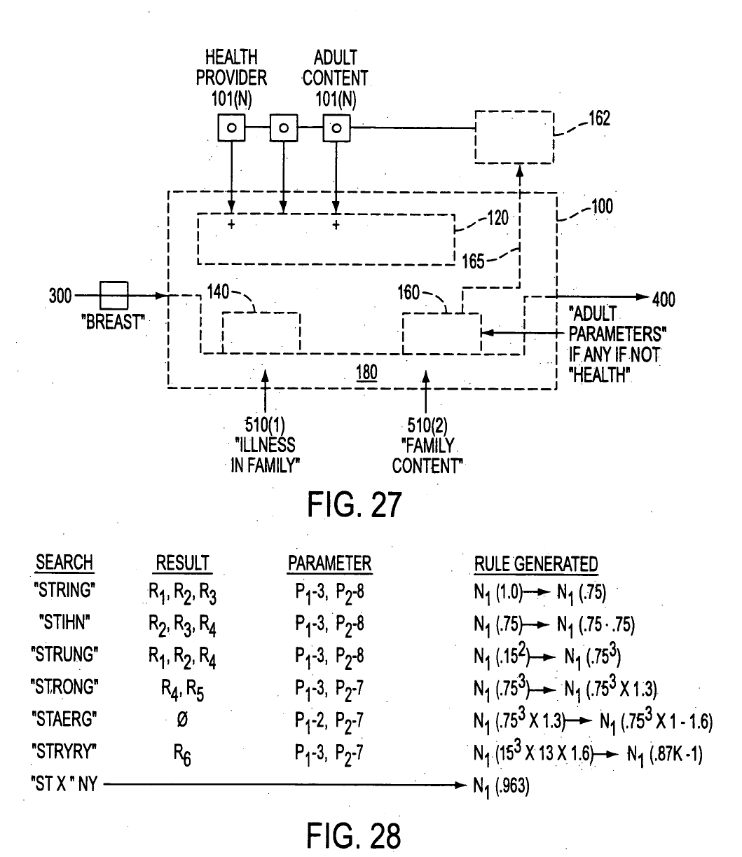

FIG. 27 illustrates an example of a genetic component as it may be implemented in the present invention. As can be appreciated by those skilled in the art, genetic components have been described in the invention. For example, above, the human review factor H(4) or the authoritative component was matched to other neural scores N(3) and N(4). In the illustration, the genetic algorithm is a content blocking technique for family suitability based on the firing of a particular neurode. The parametric data includes that the user does a lot of health-related research or that a family member is sick 510(1), but also is interested in keeping the search to family content 510(2). The search includes the word “breast” or other search term, which could be used for both adult and non-adult content searching. The fuzzy logic module 160 has learned that the word “breast” is supposed to block off the score of the adult content neural input. Thus weight given to such inputs is inverted and other information is made contingent upon the firing of such an inverted neuron. Thus no information is returned that has the adult content tag firing.

However many health related sites will tag certain pages as adult content in order to allow for sensitivity to the marketplace. Thus, the adult content blocker is able to learn manually from human input or from machine learning that the adult content neurode is not accurate for this user's purposes. The genetic algorithm determines that a health related neural input or a human input of reputable site will negate the effects of the adult content blocker for the search term “breast.” However, the algorithm may apply to other search terms that will draw both adult and non adult content. Thus, the genetic algorithm will adapt the neural input in addition to combining with other search algorithms which may apply to a common category of expression for anatomical parts or the genetic component may adapt through a neural pattern recognition.

FIG. 28 shows a table which depicts an equilibrium of a learning mechanism, such that a preliminary global rule. In a highly simplified model the expression “String” is evaluated such that each letter corresponds to a neurode with a weight of one. The initial search results indicated that the vowel position was less indicative of the relevant results (R1, R2, R3) and thus reduces the 4^{th} letter neural weight by 0.25. In the second search for “strung” 75% of the results are similar to search 1(R2, R3, R4), thus the 4^{th} letter is reduced further by a factor of 0.75. This also happened on search 3 for “strang.”

The machine cannot innately understand that “string” “strang” and “strung” are all related terms. Thus it has reduced the importance of the 4^{th} position (the vowel) more than half after the third search. However, the search term “strong” is not related and returns only 25% overlapping search results R4. Thus, the machine learns that the 4^{th} position neurode is now more relevant and adjusts the weight by a factor of 1.3. The search “streng” returns no results, boosting the weight by 1.6 and “stryng” returns only R6 which allows for a weight factor of 1.1. So at the end of the six searches, the 4th position neurode is only a bit less than 1 (0.96), which indicates that the search “STR” X “NG” will result in the 4^{th} position being slightly less of a search input factor. The learning mechanism may have enough data on this search type that it makes the preliminary global rule of the weights, a global rule.

Table 1.1 shows a series of example “spider level” search which may be implemented in as neural input from the data collection system 50. As can be appreciated, the existence of data collection services which may be purchased for use with the present invention or generated by the categorized different than the examples in table 1.2 provide. However, the 50 or so criteria described may provide for an example of types of search criteria would be processed as neural input adapted by learning mechanisms.

The actual calculation of the search results would be highly dependent on the particular implementation of the invention. Certainly a “score” based on weights of the neural inputs would be one embodiment of the invention. Of course, the advantage of the present invention over the prior art is the fuzzy logic or expert rules that may be implemented at different levels. Thus, a weighted score based on the neural input may adapt by a number of fuzzy mechanisms at a number of computational points.

A “score” from the generation of a result from a neural network is not an accurate description, however, pattern recognition (discussed below) which is the predominant computational solution in many neural networks may not be appropriate.

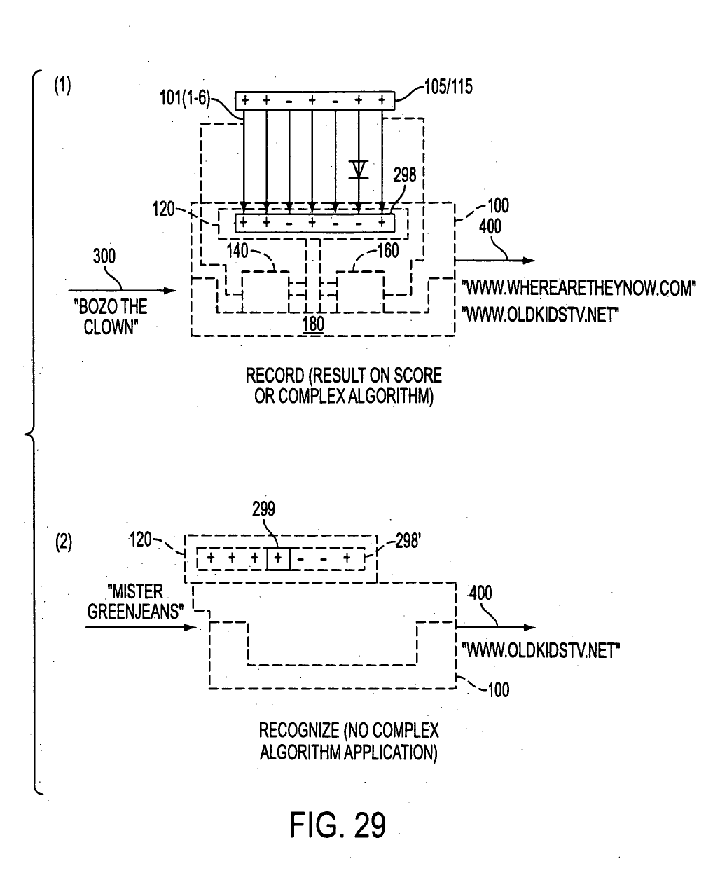

FIG. 29 illustrates a method of an embodiment of the present invention from search inquiry for a pattern recognition technique for finding a search result. The neural network processor 120 receives pattern of inputs 125. The processor 120 attempts to match it to previous recognized and stored 127 processes 124 and when it finds a match it loads those search results and returns the expressions to the output 400. If the search inquiry 300(2) was different that from the one which provided the previous pattern 125, the search processing system then learns that the two search inquiries 300(1), 300(2) produce the same pattern.

There is redundancy in the predictive models provided in the present invention. This means that the search processor tolerates absent and poor data very well compared with the prior art. As can be appreciated the minimally tolerated input for returning an accurate search answer will be reduced by the machine learning over time.

The above examples and embodiments are meant to be illustrative only and are not exhaustive. As can be appreciated by those skilled in the art, many of the structures described can be virtual or physical and combined in one machine or several. Furthermore, the modularity of any given component must be appreciated. For example, three (or any number of) neurodes may be combined into a single one if the AI search processor determines that it is appropriate under the circumstances. Thus, the scope of the invention should not be limited to the example provided above, but rather to the spirit of the invention.

1. A method for processing a search request including the steps of:
determining if a search request activates one of a set of search rules; if said search request activates said at least one search rule, then applying said search rule;
setting a set of initial input weight adjustments based on said at least one search rule, said search rule based on at least one user preference;
processing a set of inputs responsive to a collection of data, said set of inputs adjusted by said set of weight adjustments, said processing resulting in a set of filtered data; and
adapting a search engine based on learning, said learning including at least comparing said set of filtered data to either a set of previously filtered data or a feedback mechanism.

2-6. (Cancelled.)

7. The method as recited in claim 1, further including the step of accessing external data, wherein said search rule may also be activated or altered by said user data.

8-29. Cancelled).

30. A method for finding a document or page located on a network through a uniform resource locator in which a search engine including executable instructions running on one or more computing devices evaluates data regarding the characteristics of a plurality of said pages or documents and returns a set of one or more relevant documents in response to a search inquiry consisting of search terms, wherein the improvement includes using a neural network and user data to evaluate said data and return said set of one or more relevant documents, said neural network using weighting at least partially based on said user data in evaluating said document characteristics.

31. (Cancelled)

32. The method as recited in claim 30, wherein said neural network is controlled by set of one or more expert rules, wherein said set of one or more expert rule is activated by at least one component of user data.

33-35. (Cancelled)

36. The method as recited in claim 32, further including the act of training said neural network by evaluating said set of one or more relevant documents by comparing said set of one or more relevant documents to a previously returned search result.

37. The method as recited in claim 32, further including the act of training said neural network by evaluating said set of one or more relevant documents through a user feedback mechanism.

38. The method as recited in claim 37, wherein said user feedback mechanism is comprised at least partially of said user data.
